(19) United States
(12) Patent Application Publication
(10) Pub. No.: US 2023/0126052 A1
(43) Pub. Date: Apr. 27, 2023

(54) SYSTEM AND METHOD FOR ANALYSIS OF SPOKEN NATURAL LANGUAGE TO DETECT PROMOTION PHRASES FOR PROVIDING FOLLOW-UP CONTENT

(71) Applicant: SoundHound, Inc., Santa Clara, CA (US)

(72) Inventors: Keyvan MOHAJER, Los Gatos, CA (US); Michael Zagorsek, Yountville, CA (US)

(73) Assignee: SoundHound, Inc., Santa Clara, CA (US)

(21) Appl. No.: 17/511,575

(22) Filed: Oct. 27, 2021

(51) Int. Cl. G06Q 30/02

(52) U.S. Cl. CPC G06Q 30/0251

(57) ABSTRACT

Systems and methods are disclosed that enable a user to speak a promoted phrase in response to a voice content or voice advertisement, which includes the promoted phrase. When the promoted phrase is spoken, then additional content is provided, such as additional advertisement. According to various examples, detection of the user speaking the promoted phrase is enabled once the voice advertisement ends. According to various examples, the additional content is related to the promoted phrase. According to various examples, detection of the user speaking the promoted phrase is done within a time frame; once the time frame is exceeded, detection of the user speaking the promoted phrase is disabled.

### FIELD OF TECHNOLOGY

The present technology is in the field of computer systems and, more specifically, related to serving additional content in response to a promoted phrase being spoken.

### BACKGROUND

While an advertisement is being played, there is a short window of time during the advertisement that a user may interact with the advertisement. Although the user may be interested in the advertisement in the future, the user may not be interested in the advertisement now. In this situation, an advertiser misses identifying engagement opportunities due to the timing of the advertisement.

### SUMMARY OF THE INVENTION

Systems and methods are disclosed that enable a user to speak a promoted phrase in response to a voice advertisement that includes the promoted phrase. The user will then be provided additional advertisement content. According to various examples, detection of the promoted phrase is enabled once the voice advertisement ends. According to various examples, the additional advertisement content is related to the voice advertisement or the promoted phrase. According to various examples, detection of the user speaking the promoted phrase is done within a time frame. Once the time frame has lapsed, detection of the user speaking the promoted phrase may be disabled. This avoids unexpected future delivery of the additional content by the user or others. Additionally or alternatively, detection of the user speaking the promoted phrase can be disabled in response to detecting the user speaking promoted phrase.

According to various examples, the user interacts with the device before detection of the spoken phrase. For example, the user presses a button on a device to enable detection of the spoken phrase. Releasing the button disables detection. By requiring a button for detection of the spoken phrase, ambient speech does not cause false positive detection if the phrase or a similar-sounding phrase is spoken. Avoiding false positives improves user experience and therefore positive reviews of devices and services, resulting in higher sales.

According to various examples, detection of the promoted phrase may be generally enabled or disabled. For example, the user may choose to have promoted phrase detection enabled as a feature within a device that supports voice interaction. In some systems, disabling phrase detection aids in preserving privacy or limiting access to content that might be inappropriate for some settings or for some types of people such as children. This enables sales to users and use case markets that otherwise could not be reached.

According to various examples, before serving additional advertisement content is performed, a determination is made if the same user that listened to the voice advertisement also spoke the promoted phrase. Detecting which user spoken the promoted phrase can be performed with voice fingerprinting, with beamforming using multiple microphones to detect the relative direction of speech, with radio frequency or other type of electromagnetic signals, such as Bluetooth, presence detection, by camera, radar, or similar types of sensing the presence of people. Additional advertisement content is served when the same user that spoke the promoted phrase also was served the voice advertisement. Delivering content, conditionally, only to the same user that listened to the voice advertisement, ensures that the listener is aware of the context of the advertisement when receiving the additional content. That improves user satisfaction and advertisement success. According to various examples, serving additional advertisement content may depend on the other people and/or devices that could hear/record the additional advertisement content.

According to various examples, the additional advertisement includes a call to action (CTA). This encourages consumers to further engage with content from a vendor, which increases the likelihood of a sale conversion and, therefore, profitability for the vendor and the service that delivers the advertisements and additional content. According to various examples, the additional advertisement includes additional questions for the user and the response to the user is based on the additional questions. Additional questions also encourage user engagement and advertisement conversion to sales.

### BRIEF DESCRIPTION OF THE DRAWINGS

FIG. 1 shows a process of enabling a user to interact with an advertisement for a spoken phrase in accordance with various aspects and examples.

FIG. 2 shows a process of enabling a user to interact with an advertisement for a spoken phrase after the advertisement has been served in accordance with various aspects and examples of the invention.

FIG. 3 shows a process of enabling a user to interact with an advertisement within a time frame for a spoken phrase after the advertisement has been served in accordance with various aspects and examples of the invention.

FIG. 4 shows a process of enabling a user to interact with an advertisement by interacting with the device before a spoken phrase after the advertisement has been served in accordance with various aspects and examples of the invention.

FIG. 5 shows a process of enabling a user to interact with an advertisement allowing detection of a promoted phrase before a spoken phrase after the advertisement has been served in accordance with various aspects and examples of the invention.

FIG. 6 shows a process of enabling a user to interact with an advertisement allowing detection of a promoted phrase within a time frame before a spoken phrase after the advertisement has been served in accordance with various aspects and examples of the invention.

FIG. 7 shows a process of enabling a same user to interact with an advertisement previously consumed by the same user after the advertisement has been served in accordance with various aspects and examples of the invention.

FIG. 8 shows a process of enabling a same user to interact with an advertisement previously consumed by the same user that contains a call to action after the advertisement has been served in accordance with various aspects and examples of the invention.

FIG. 9 shows a process of enabling a user to interact with an advertisement that asks additional questions after the advertisement has been served in accordance with various aspects and examples of the invention.

FIG. 10 shows an apparatus that enables a user to interact with an advertisement for a spoken phrase in accordance with various aspects and examples of the invention.

FIG. 11 is an example of a user interacting with an advertisement for a spoken phrase in accordance with various aspects and examples of the invention.

FIG. 12 is an example of a user interacting with an advertisement for a spoken phrase in accordance with various aspects and examples of the invention.

FIG. 13A shows a rotating disk non-transitory computer readable medium according to an embodiment of the invention.

FIG. 13B shows Flash RAM chip non-transitory computer readable medium according to an embodiment of the invention.

FIG. 14 is a schematic illustration of a server in accordance with various aspects and examples of the invention.

FIG. 15 is a schematic illustration showing a system in accordance with various aspects and examples of the invention.

### DETAILED DESCRIPTION

The following describes various examples of the present technology that illustrate various interesting aspects. Generally, examples can use the described aspects in any combination. Statements herein reciting principles, aspects, and examples are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one,” “an,” “certain,” “various,” and “cases,” “examples” or similar language means that a particular aspect, feature, structure, or characteristic described in connection with the example is included in at least one embodiment of the invention. Thus, appearances of the phrases “in one case,” “in at least one example,” “in an example,” “in certain cases,” and similar language throughout this specification may, but do not necessarily, all refer to the same embodiment or similar embodiments. Furthermore, aspects and examples of the invention described herein are merely exemplary, and should not be construed as limiting of the scope or spirit of the invention as appreciated by those of ordinary skill in the art. The disclosed invention is effectively made or used in any example that includes any novel aspect described herein. Furthermore, to the extent that the terms “including”, “includes”, “having”, “has”, “with”, or variants thereof are used in either the detailed description and the claims, such terms are intended to be inclusive in a similar manner to the term “comprising.” In examples showing multiple similar elements, even if using separate reference numerals, some such examples may work with a single element filling the role of the multiple similar elements.

### Voice Advertisement Method

The following describes systems of process steps and systems of machines and components for serving additional advertising content in response to a promoted phrase being spoken by a user while the promoted phrase was part of a voice advertisement. Some implementations use computers that execute software instructions stored on non-transitory computer readable media. Examples below show design choices for various aspects of such systems. In general, design choices for different aspects are independent and can work together in any combination.

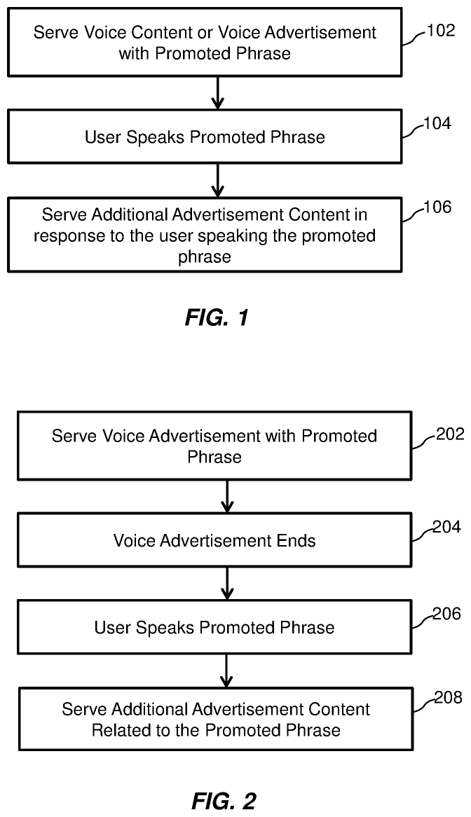

Referring now to FIG. 1, according to one or more examples, a process is shown that enables a user to interact with any content, including content that is an advertisement, by speaking a phrase. At step 102, a voice content or voice advertisement that includes a promoted phrase is provided or served from a device. The promoted phrase is intended to cause or initiate an interaction or a response from the user. According to various examples, the device may be any electronic device capable of delivering a voice advertisement to a user. For example, the device may be a voice enabled personal assistant (e.g., a household assistant device), a sound bar, a smart speaker, a TV, a radio, a smart phone, a tablet, a desktop computer, a computer peripheral device (e.g., a computer printer), a wearable electronic device (e.g., smart watch), an automobile, a household appliance (e.g., voice enabled refrigerator, a washer, a dryer, a robot vacuum, a ceiling fan, etc.), a thermostat (e.g., a controller for a home heating system), an anthropomorphic robots, an internet of things (IoT) device, headset (e.g., wireless earphones), etc.

The promoted phrase can be any phrase within the content or advertisement that can be used to trigger follow-on content, advertisement, interaction, or one or more question. For example, when the advertisement is “Melody Basset Hound Insurance, say ‘best friend’ to keep you safe” then the promoted phrase can be “best friend.” In another example, when the advertisement is “Acoustic Plott Hound Banking, just say ‘houndecoin’ to open your account”, then the promoted phrase can be “houndecoin”. According to various examples, the promoted phrase can be any sound a human can make. For example, the advertisement could be “for the best Halloween experience, scream” and the promoted phrase could be someone screaming. For another example, the advertisement could be “for the funniest comedy show you have seen, laugh” and the promoted phrase could be laughter. For another example, the advertisement could be “for your car to be as clean as a whistle, whistle” and the user whistling could be the promoted phrase. According to various examples, an advertisement may contain multiple promoted phrases. According to various examples, a user may specify the promoted phrase. For example, when the voice advertisement is “Melody Basset Hound Insurance, say ‘best friend’ to keep you safe. You can also say what word you would like to use to get more information”, then the user can say “insurance” to specify the promoted phrase. Later, when the user says “insurance”, insurance will be understood to be the promoted phrase.

According to various examples, the voice advertisement may include a time frame to speak the promoted phrase. For example, the voice advertisement may be “Melody Basset Hound Insurance, say ‘best friend’ within two hours to keep you safe.” In another example, the voice advertisement may be “Acoustic Plott Hound Banking, just say ‘houndecoin’ any time today to open your account.”

According to various examples, the voice advertisement with promoted phrase may be created by any source. For example, a sales writer may write and/or speak the voice advertisement with promoted phrase and indicate what the promoted phrase is. For another example, the advertisement may be created by a machine learning algorithm trained with data about the user, other users, and/or potential users.

At step 104, a user speaks the promoted phrase from the voice advertisement. For example, when the advertisement is “Acoustic Plott Hound Banking, just say ‘houndecoin’ to open your account” and the user says “houndecoin”, an additional advertisement from Acoustic Plott Hound Banking about opening an account is served. According to various examples, a variation of the promoted phrase can be recognized as the promoted phrase. For example, when the promoted phrase is “home mortgage”, phrases such as “house mortgage”, “home loan”, “mortgage, “mortgage rate”, etc. may be recognized as the promoted phrase. According to various examples, part of the promoted phrase may be recognized as the promoted phrase. For example, when the promoted phrase is “home mortgage”, the phrase “home”, “mort”, “hm”, etc. may be recognized as the promoted phrase. According to various examples, the promoted phrase may be a reference to an aspect of the advertisement. For example, when the user says “tell me more about the banking advertisement” then this could be recognized as the promoted phrase of the advertisement. For another example, when the user says “replay that mortgage ad” then this could be recognized as the promoted phrase of the mortgage advertisement. According to various examples, synonyms of the promoted phrase can be recognized as the promoted phrase. For example, when “home mortgage” is the promoted phrase, “house mortgage” could be recognized as the promoted phrase. According to various examples, similar meanings may be used to recognize the promoted phrase. For example, when “home mortgage” is the promoted phrase, the phrase “condo mortgage” may be recognized as the promoted phrase. According to various examples, the nationality and/or language of the user may be used to determine what is recognized as the promoted phrase. For example, when the promoted phrase is “home mortgage” and the user speaks Spanish, then “casa mortgage” may be added to the recognized promoted phrases.

According to various examples, one device may deliver the voice advertisement and another device may listen for the promoted phrase. For example, an earphone may be used to deliver the advertisement and the microphone on a smart phone may listen for the promoted phrase to be spoken.

According to various examples, when unable to determine which promoted phrase was spoken by the user, the user may be prompted to clarify. For example, when a voice advertisement was served for both an automotive insurance advertisement and home insurance, and the user says the promoted phrase “insurance”, then the user may be prompted if they mean the automotive insurance or home insurance. The user's response will determine which additional advertisement to serve.

At step 106, additional advertisement content is served. According to various examples, the additional advertisement content is delivered in response to the user speaking a promoted phrase. According to various examples, the additional advertisement content is related to the voice advertisement.

Referring now to FIG. 2, according to one or more examples, a process is shown that enables a user to interact with an advertisement for a spoken phrase after the advertisement has been served in accordance with various examples. At step 202, a voice advertisement that includes a promoted phrase is served from an electronic device. According to various examples, step 202 may be the same or similar to step 102. At step 204, the voice advertisement ends. For example, the voice advertisement ends, and the user is served non-advertisement content. The user's speech is then monitored. At step 206, a user speaks the promoted phrase; the spoken promoted phrase is a natural language response from the user. In accordance with various examples and aspects of the invention, the natural language response includes the promoted phrase and additional spoken words. The natural language response is analyzed and the promoted phrase is detected. According to various examples, step 206 may be the same or similar to step 104. At step 208, additional advertisement content related to the promoted phrase is identified and served. For example, after the voice advertisement “Acoustic Plott Hound Banking, just say ‘houndecoin’ to open your account” is served, the user begins listening to a song. When the song is complete or when the user is no longer interested in the song, the user could speak “houndecoin” to get the additional advertisement content related to opening an account with Acoustic Plott Hound Banking. According to various aspects and embodiment of the invention, the user is not required to speak the promoted phrase during the content following the advertisement. The user may speak the promoted phrase during any time frame after the voice content or voice advertisement ends. Step 208 may be the same or similar to step 106.

In accordance with various aspects and embodiments of the invention, the user speaks the promoted phrase and includes additional delivery information to allow for delivery of the additional content at a different time and via different means. For example, the user speaks the promoted phrase and states a date and time for re-delivery of the voice content or delivery of additional content. In accordance with various aspects and embodiments of the invention, the user can provide instructions on how to receive re-delivery or delivery of additional content, such as via any one or more delivery methods, including: a text message; an email message; a phone call; or mail to a physical address. The user's information may be stored and automatically provided or it may be provided by the user as part of the user's spoken words with the promoted phrase.

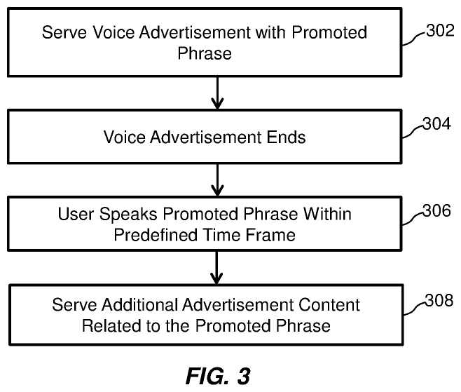

Referring now to FIG. 3, according to one or more examples, a process is shown that enables a user to interact with an advertisement within a time frame for a spoken phrase after the advertisement has been served in accordance with various examples. At step 302, a voice advertisement that includes a promoted phrase is served from an electronic device. According to various examples, step 302 may be the same or similar to step 102.

At step 304, the voice advertisement ends. According to various examples, step 304 may be the same or similar to step 204.

At step 306, a user speaks the promoted phrase from the voice advertisement within a time frame. According to various examples, the time frame is referenced to an event within the voice advertisement. According to various examples, the time frame is referenced to and relative to the intended duration of the voice advertisement. For example, the time frame is defined from the end of the advertisement, the beginning of the advertisement, the midpoint of the advertisement, the total length of time frame allotted for the advertisement, or when the promoted phrase is spoken, etc. According to various examples, the time frame may be defined from any source capable of defining the time frame. For example, the time frame may be specified globally for every advertisement, an advertiser may specify the time frame on per advertisement basis and/or advertisement group basis, the user may specify the time frame, the time frame may be determined based on user preferences and/or previous actions, etc. According to various examples, the time frame may be inclusive or exclusive of the end points. For example, if the time frame is set to be five minutes and the promoted phrase is spoken at five minutes, then the spoken promoted phrase may be determined to have been spoken within the time frame (i.e., inclusive) or not to have been spoken within the time frame (i.e., exclusive). According to various examples, speaking the promoted phrase may be the same or similar to step 104.

At step 308, additional advertisement content related to the promoted phrase is served. According to various examples, once the time frame has expired, when a user speaks the promoted advertisement, the additional advertisement is not served. For example, if the time frame is specified as one hour after the voice advertisement ends, then if a user speaks the promoted phrase thirty minutes after advertisement ends, the user would be served the additional advertisement. On the other hand, if a user speaks the promoted phrase two hours after the voice advertisement ends, the user will not be served the additional advertisement. According to various examples, step 308 is the same or similar to step 208.

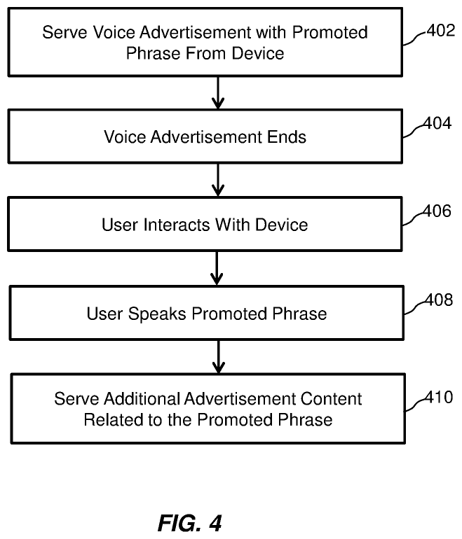

Referring now to FIG. 4, according to one or more examples, a process is shown that enables a user to interact with an advertisement by interacting with the device before a spoken phrase after the advertisement has been served in accordance with various examples. At step 402, a voice advertisement that includes a promoted phrase is served from an electronic device. According to various examples, step 402 can be the same or similar to step 102. At step 404, the voice advertisement ends. According to various examples, step 404 is the same or similar to step 204.

At step 406, a user interacts with the device. According to various examples, the user interaction informs the device to listen for a promoted phrase. According to various examples, any user interaction with the device may be considered an interaction. For example, a user can press a button, speak a wake-up phrase, move the device (e.g., shake, turn over, etc.), make a gesture toward the device (e.g., wave a hand), etc. It is appreciated that the device would have hardware to implement the user interaction. For example, to determine if a device is moved would require one or more sensors such as an accelerometer, a gyroscope, a camera, etc.

At step 408, a user speaks the promoted phrase from the voice advertisement. According to various examples, the user presses a button before speaking the promoted phrase. According to various examples, the user presses and holds a button before speaking the promoted phrase. According to various examples, step 408 may be the same or similar to step 104.

At step 410, additional advertisement content related to the promoted phrase is served. According to various examples, step 410 may be the same or similar to step 208.

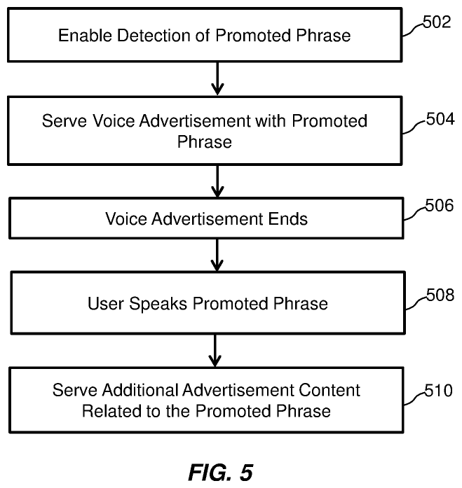

Referring now to FIG. 5, according to one or more examples, a process is shown that enables a user to interact with an advertisement allowing detection of promoted phrase before a spoken phrase after the advertisement has been served in accordance with various examples. At step 502, detection of any one or more promoted phrases being spoken is enabled. According to various examples, the user may be prompted to enable detection of the promoted phrase. For example, on initial setup the user may be prompted to enable detection of the promoted phrase, prompted during software upgrades, prompted before each session, prompted after device reboots, etc. According to various examples, detection of the promoted phrase may be set to a default value. For example, on initial setup the detection of the promoted phrase may be set to true or false. According to various examples, the user may change the enablement/disablement for detection of the promoted phrase. For example, the user may say “disable detection of promoted phrases.” According to various examples, an advertiser may require enablement of detection of a promoted phrase to access certain content. For example, an advertiser may require enablement of detection of the promoted phrase to access a seminars content. According to various examples, the user may specify a time frame to enable/disable detection of the promoted phrase. For example, detection of the promoted phrase may only be enabled during business hours (e.g., 9 am to 5 pm on Monday-Friday). According to various examples, detection of the promoted phrase may be dependent on the environment of the user. For example, enablement of promoted phrase detection may depend on if the user is with other people or alone, if the user is using a headset, etc. According to various examples, the user may define the promoted phrase enablement on a more granular resolution than a global bases. For example, the user may enable promoted phrase detection for just banking advertisements, certain promoted phrases, etc.

At step 504, a voice advertisement that includes a promoted phrase is served from an electronic device. According to various examples, the user may speak a phrase to enable detection of promoted phrases. For example, the user may say “more” during the voice advertisement to enable detection of promoted phrases. According to various examples, the user may speak a phrase to disable detection of promoted phrases. For example, the user may say “no” during the advertisement to disable detection of promoted phrases. According to various examples, step 504 may be the same or similar to step 102.

At step 506, the voice advertisement ends. According to various examples, step 506 may be the same or similar to step 204. At step 508, a user speaks the promoted phrase from the voice advertisement. According to various examples, step 508 may be the same or similar to step 104. At step 510, additional advertisement content related to the promoted phrase is served. According to various examples, step 510 may be the same or similar to step 208.

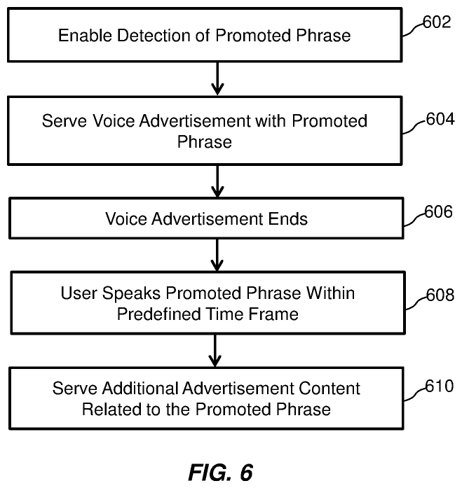

Referring now to FIG. 6, according to one or more examples, a process is shown that enables a user to interact with an advertisement allowing detection of promoted phrase within a time frame before a spoken phrase after the advertisement has been served in accordance with various examples. At step 602, detection of the promoted phrase being spoken is enabled. According to various examples, step 602 may be the same or similar to step 502. At step 604, a voice advertisement that includes a promoted phrase is served from an electronic device. According to various examples, step 604 may be the same or similar to step 504 and/or step 102. At step 606, the voice advertisement ends. According to various examples, step 606 may be the same or similar to step 204. At step 608, a user speaks the promoted phrase from the voice advertisement within a time frame. According to various examples, step 608 may be the same or similar to step 306. At step 610, additional advertisement content related to the promoted phrase is served. According to various examples, step 610 may be the same or similar to step 208.

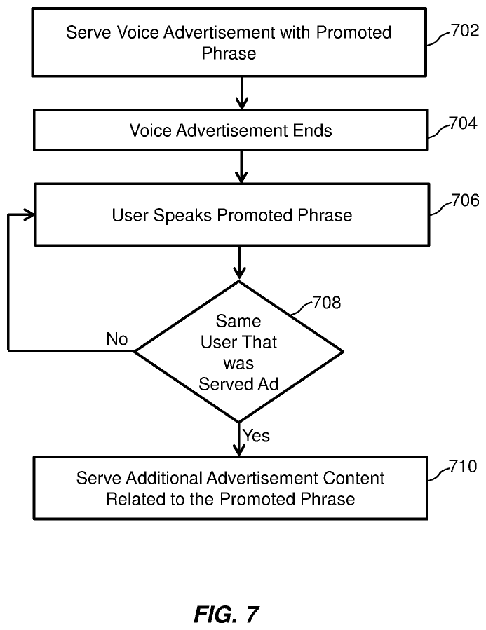

Referring now to FIG. 7, according to one or more examples, a process is shown that enables a same user to interact with an advertisement previously consumed by the same user after the advertisement has been served in accordance with various examples. At step 702, a voice advertisement that includes a promoted phrase is served from an electronic device. According to various examples, step 702 can be the same or similar to 102. At step 704, the voice advertisement ends. According to various examples, step 704 may be the same or similar to step 204. At step 706, a user speaks the promoted phrase from the voice advertisement and the spoken promoted phrase is captured. According to various examples, speaking the promoted phrase happened within a time frame. According to various examples, step 706 may be the same or similar to step 104.

At step 708, a determination is made if the user that spoke the promoted phrase is the same user that was served the voice advertisement with the promoted phrase. According to various examples, voice recognition may be used to determine if the same user that was served the voice advertisement spoke the promoted phrase. For example, when a user starts to engage with content using a voice command, the device recognizes the user's voice and the device stores that the user was the person served the voice advertisement. Then when a user speaks the promoted phrase, the user's voice is compared to the user that was served the voice advertisement. For another example, the device could have the user log in before using the device. A login could be speaking the user's name, clicking the user's avatar, etc. The identity of a user could be confirmed with a password, a personal identification number (PIN), (e.g., four-digit PIN), etc. A potential benefit of determining if the same user spoke the promoted phrase as was served the voice advertisement is to protect a child from hearing an advertisement intended for an adult, such as an adult beverage advertisement. Another potential benefit of determining if the same user spoke the promoted phrase as was served the voice advertisement is for better targeted advertisement. For example, a child could not open a bank account. Another potential benefit of determining if the same user spoke the promoted phrase as was served the voice advertisement is to avoid disclosing personal information. For example, a user may be shopping for a birthday present and not want a product the user was shopping for to be served as an advertisement while in the presence of the intended recipient of the present.

According to various examples, determining if the same user that was served the voice advertisement spoke the promoted phrase, also includes determine if other people present. For example, a user may be searching for a new home and does not want the user's current roommate to know about the new home search. Determining other people can be performed by any way of detecting the presence of other people. For example, recognizing voices in the room, using one or more cameras to detect other people, using proximity sensors to detect other people, detecting radio signal emissions from electronic devices of other people (e.g., another person's smart phone), etc.

According to various examples, determining if the same user that was served the voice advertisement spoke the promoted phrase also includes determining the age and/or gender of other people present. For example, in a room with all adults, an adult beverage would be more appropriate than in a room with both adults and children. Age detection can be done, for example, by voice characterization or camera image analysis.

According to various examples, determining if the same user that was served the voice advertisement spoke the promoted phrase also includes determining if the user is listening via a private method. For example, if the user is using headphones, then other people may not be able to hear the advertisement thus an advertisement may be served.

When, in step 708, the same user that spoke the promoted phrase was served the voice advertisement with the promoted phrase, step 710 is performed. When different users spoke the promoted phrase than was served the voice advertisement with the promoted phrase, step 706 is repeated. According to various examples, when one or more prompted phrase is required to be spoken within a time frame and the one or more time frames has passed, the device may stop listening for the one or more promoted phrases.

At step 710, additional advertisement content related to the promoted phrase is served. According to various examples, step 710 can be the same or similar to step 208.

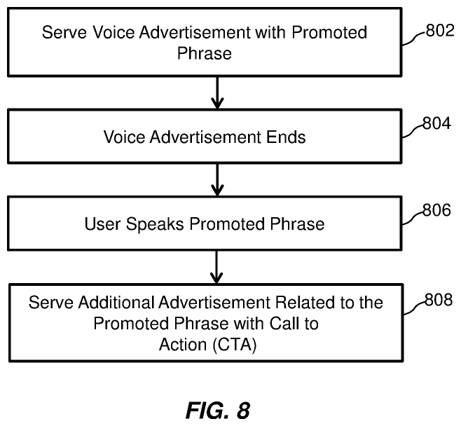

Referring now to FIG. 8, according to one or more examples, a process is shown that enables a user to interact with an advertisement previously consumed by the same user that contains a call to action after the advertisement has been served in accordance with various examples. At step 802, a voice advertisement that includes a promoted phrase is served from an electronic device. According to various examples, step 802 may be the same or similar to step 102. At step 804, voice advertisement ends. According to various examples, step 804 may be the same or similar to step 204. At step 806, a user speaks the promoted phrase from the voice advertisement. Step 806 may be the same or similar to step 106.

At step 808, additional advertisement content related to the promoted phrase with a call to action (CTA) is served. According to various examples, a CTA is the next action an advertiser prefers the user to take. For example, CTA can include scanning a quick response (QR) code, receiving discount code via a short message service (SMS), signing up for a newsletter, setting an appointment with the advertiser's sales team, setting up an account, buying a product, adding product to shopping cart, getting a sample product, etc.

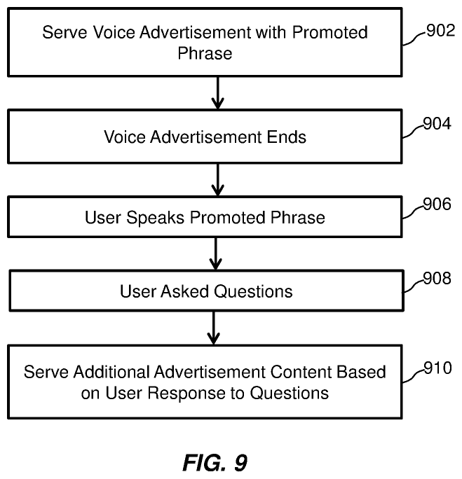

Referring now to FIG. 9, according to one or more examples, a process is shown that enables a user to interact with an advertisement that asks additional questions after the advertisement has been served in accordance with various examples. At step 902, a voice advertisement that includes a promoted phrase is served from an electronic device. According to various examples, step 902 may be the same or similar to step 102. At step 904 the voice advertisement ends. According to various examples, step 904 may be the same or similar to 204. At step 906, a user speaks the promoted phrase. According to various examples, step 906 may be the same or similar to step 206.

At step 908, the user is asked one or more questions to provide additional information the user is interested in. For example, when the user speaks a promoted phrase related to refinancing a house mortgage, questions can be asked about loan balance, current interest rate, desired loan term (e.g., thirty-year mortgage, fifteen-year mortgage), etc. For another example, when the user speaks a promoted phrase related to automotive insurance, questions can be asked about location of the automobile, type of automobile, type of insurance, insurance limits, insurance deductibles, etc.

At step 910, additional advertisement content is served based on the user response to the one or more questions. For example, when the user speaks a promoted phrase related to refinancing a house mortgage, the advertisement content may include an estimated new mortgage payment. For another example, when the user speaks a promoted phrase related to automotive insurance, the advertisement content may include a new estimated monthly automobile insurance payment. According to various examples, the additional advertisement may include a CTA.

According to various examples, the user enters a conversation dialog with the advertiser to get personalized results.

### Voice Advertisement Apparatus

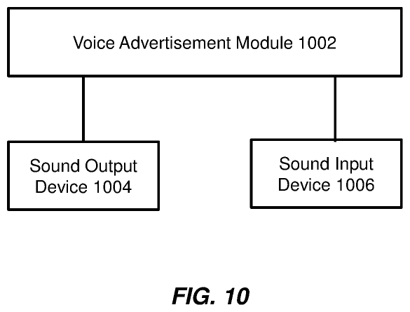

Referring now to FIG. 10, according to one or more examples, an apparatus is shown that enables a user to interact with an advertisement for a spoken phrase in accordance with various examples. According to various examples, voice advertisement module 1002 serves a voice advertisement with a promoted phrase over sound output device 1004. Sound output device 1004 may be any device capable of serving a voice advertisement to a user. For example, sound output device 1004 may be a speaker, ear buds, headset, etc. Voice advertisement module 1002 listens for the promoted phrase to be spoken using sound input device 1006. Sound input device 1006 may be any device capable of receiving a promoted phrase from a user. For example, sound input device 1006 may be a microphone. When the promoted phrase is recognized having been spoken by voice advertisement module 1002, voice advertisement module 1002 serves additional advertisement content.

According to various examples, detection of the promoted phrases by voice advertisement module 1002 may be delayed until the voice advertisement with promoted phrase has ended. According to various examples, the additional advertisement content served by voice advertisement module 1002 is related to the promoted phrase.

According to various examples, voice advertisement module 1002 listens for the promoted phrase for a time frame.

According to various examples, detection of the promoted phrase by voice advertisement module 1002 may be enabled or disabled.

According to various examples, detection of the promoted phrase by voice advertisement module 1002 includes determining the promoted phrase is spoken by the same user that was served the voice advertisement with promoted phrase and promoted phrase is determined to have been spoken when the same user that spoke the promoted phrase was also served the voice advertisement.

According to various examples, serving additional advertisement by voice advertisement module 1002 includes a CTA.

According to various examples, after voice advertisement module 1002 determines a promoted phrase was spoken by a user, voice advertisement module 1002 asks additional one or more questions using sound output device 1004. After voice advertisement module 1002 receives the answers to these questions via sound input device 1006, voice advertisement module 1002 provides advertisement content based on the user's response to the one or more questions.

According to various examples, voice advertisement module 1002, sound output device 1004, and sound input device 1006 may perform any step, both in part and in whole, from any of the FIGS. 1 through 9.

### Voice Advertisement Examples

Referring now to FIG. 11, according to one or more examples, an example is shown of a user interacting with an advertisement for a spoken phrase in accordance with various examples. Voice enabled device 1102 has speaker 1104 and a microphone (not shown). According to various examples, voice enabled device 1102 delivers the voice advertisement “Melody Basset Hound Insurance, say ‘best friend’ to keep you safe” that includes the promoted phrase “best friend”. When the user speaks the promoted phrase “best friend” additional advertisement content is served. According to various examples, the additional advertisement content is related to the promoted phrase. According to various examples, the promoted phrase by the user is spoking within a time frame. According to various examples, the user interacts with the device before speaking the promoted phrase. For example, the user may press a button before speaking the promoted phrase. According to various examples, detection of the promoted phrase may be enabled and disabled. According to various examples, voice enabled device 1102 may perform any of the steps or functions, both in part and in whole, for any of the methods and/or apparatuses of FIGS. 1 through 10 unless the combination of features would render the methods or apparatuses inoperable.

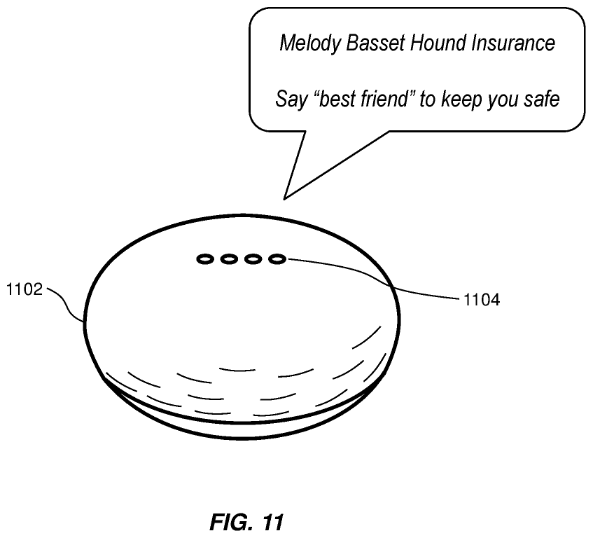

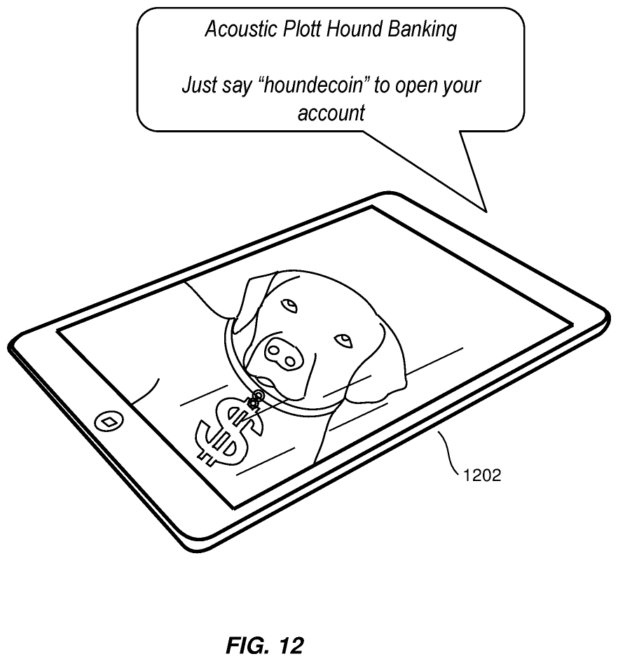

Referring now to FIG. 12, according to one or more examples, an example is shown of a user interacting with an advertisement for a spoken phrase in accordance with various examples. Smart phone 1202 includes a speaker (not shown) and a microphone (not shown). According to various examples, Smart phone 1202 delivers the voice advertisement “Acoustic Plott Hound Banking, just say ‘houndecoin’ to open your account” that includes the promoted phrase “houndecoin”. When the user speaks the promoted phrase “houndecoin” additional advertisement content is served. According to various examples, smart phone 1202 may perform any of the steps or functions, both in part and in whole, for any of the methods and/or apparatuses of FIGS. 1 through 11 unless the combination of features would render the methods or apparatuses inoperable.

According to various examples, steps or functions, both in part and in whole, for the methods and/or apparatuses of FIGS. 1 through 12 may be performed by combinations of a user's one or more devices (e.g., smart phone), one or more remote computation devices (e.g., server, cloud computing, etc.), and combinations of the preceding.

According to various examples, when the voice advertisement with a promoted phrase is “Are you still making mortgage payments based on high interest rates? Just say ‘home mortgage’ in the next 2 hours and I'll show you how much others are saving though refinancing options.” then when user says, “home mortgage”, the user is served a longer video with examples and a CTA.

According to various examples, when the voice advertisement with a promoted phrase is “did you know 59 seconds can save you 19% or more on car insurance. Just say ‘Acme Insurance’ into you voice remote in the next 2 hours to calculate your new rates”. Then, when the user says “Acme Insurance” the ad delivery system ask follow-up questions and the user answers about location, type of car, etc. and receives a rate quote from Acme Insurance.

According to various examples, when the voice advertisement with a promoted phrase is “why did mascot cross the road? Press the voice button and say ‘mascot’ in the next 2 hours for the answer and tips on how to bundle and save on car insurance” then when the user says “mascot” then the user is served a longer advertisement with the punchline, tips, and CTA.

According to various examples, when the voice advertisement with a promoted phrase is “did you know that your skin renews itself every 28 days? Just say ‘new skin’ in the next two hours and I'll give you some skin care advice based on your skin type.” then the user says “new skin” then the user is able to interact with the advertiser by answering questions and getting custom advice for skin care products.

According to various examples, when the voice advertisement with a promoted phrase is “did you know that people who take care of their skin are more likely to make other healthy choices? Say ‘glow’ in the next 2 hours and I'll let you in on some beauty secrets.” then when the user says “glow” the user is served a longer video advertisement with tips and a CTA.

### Voice Advertisement Computer Readable Medium (CRM)

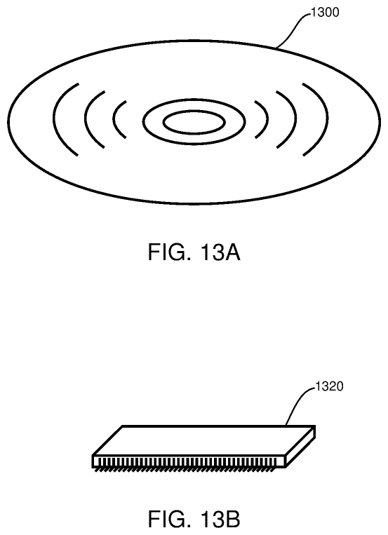

Referring now to FIG. 13A, a non-transitory computer readable medium 1300 that is a rotating magnetic disk is shown. Data centers commonly use magnetic disks to store code and data for servers. The non-transitory computer readable medium 1300 stores code that, if executed by one or more computers, would cause the computer to perform steps of methods described herein. Rotating optical disks and other mechanically moving storage media are possible.

Referring now to FIG. 13B, an example non-transitory computer readable medium 1320 that is a Flash random access memory (RAM) chip is shown. Data centers commonly use Flash memory to store code and data for servers. Mobile devices commonly use Flash memory to store code and data for system-on-chip devices. The non-transitory computer readable medium 1320 stores code that, if executed by one or more computers, would cause the computer to perform steps of methods described herein. Other non-moving storage media packaged with leads or solder balls are possible. Any type of computer-readable medium is appropriate for storing code according to various examples.

In certain examples, a non-transitory computer-readable storage medium may be provided that stores instructions to implement any of the described examples herein. The non-transitory computer readable medium may comprise one or more of a rotating magnetic disk, a rotating optical disk, a flash random access memory (RAM) chip, and other mechanically moving or solid-state storage media.

Various examples are methods that use the behavior of either or a combination of humans and machines. Method examples are complete wherever in the world most constituent steps occur. Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof.

### Server Implementation

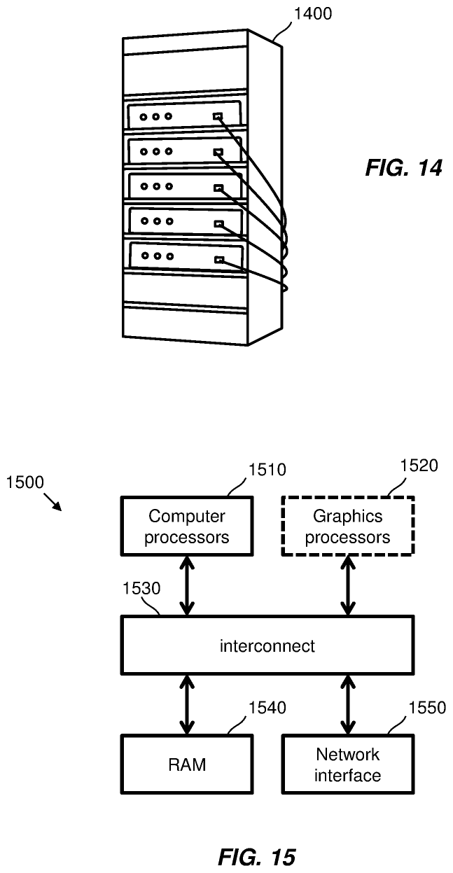

Referring now to FIG. 14, a multi-processor server system 1400 is shown, which may be used to implement the terminals and/or perform the methods of the various examples. The server system 1400 includes a multiplicity of network-connected computer processors that executed code or run software in parallel.

Referring now to FIG. 15, a block diagram of a system 1500 that can be used to implement the various examples. The system 1500 includes computer processors (CPU) 1510, a multicore cluster of graphics processor (GPU) 1520. The processors connect through a board-level interconnect 1530 to random-access memory (RAM) devices 1540 for program code and data storage, such a buffering of main meeting during a sidebar conversation. The system 1500 also includes a network interface 1550 to allow the processors to access a network such as a local area network (LAN) or the internet. By executing instructions stored in RAM devices 1540 through interconnect 1530, the CPUs 1510 and/or GPUs 1520 perform steps of methods as described herein. Embedded and mobile devices may have a similar arrangement of components but with other resources.

Practitioners skilled in the art will recognize many possible modifications and variations. The modifications and variations include any relevant combination of the disclosed features. Descriptions herein reciting principles, aspects, and examples encompass both structural and functional equivalents thereof.

Various embodiments are methods that use the behavior of either or a combination of humans and machines. The behavior of either or a combination of humans and machines (instructions that, when executed by one or more computers, would cause the one or more computers to perform methods according to examples described and claimed and one or more non-transitory computer readable media arranged to store such instructions) embody methods described and claimed herein. Each of more than one non-transitory computer readable medium needed to practice the invention described and claimed herein alone embodies the invention. Method embodiments are complete wherever in the world most constituent steps occur. Some embodiments are one or more non-transitory computer readable media arranged to store such instructions for methods described herein. Whatever entity holds non-transitory computer readable media comprising most of the necessary code holds a complete embodiment. Some embodiments are physical devices such as semiconductor chips; hardware description language representations of the logical or functional behavior of such devices; and one or more non-transitory computer readable media arranged to store such hardware description language representations.

Although the invention has been shown and described with respect to a certain preferred embodiment or embodiments, it is apparent that equivalent alterations and modifications will occur to others skilled in the art upon the reading and understanding of this specification and the drawings. Practitioners skilled in the art will recognize many modifications and variations. The modifications and variations include any relevant combination of the disclosed features. In particular regard to the various functions performed by the above described components (assemblies, devices, systems, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments. In addition, while a particular feature may have been disclosed with respect to only one of several embodiments, such feature may be combined with one or more other features of the other embodiments as may be desired and advantageous for any given or particular application.

Some embodiments of physical machines described and claimed herein are programmable in numerous variables, combinations of which provide essentially an infinite variety of operating behaviors. Some embodiments herein are configured by software tools that provide numerous parameters, combinations of which provide for essentially an infinite variety of physical machine embodiments of the invention described and claimed. Methods of using such software tools to configure hardware description language representations embody the invention described and claimed. Physical machines can embody machines described and claimed herein, such as: semiconductor chips; hardware description language representations of the logical or functional behavior of machines according to the invention described and claimed; and one or more non-transitory computer readable media arranged to store such hardware description language representations.

In accordance with the teachings herein, a client device, a computer and a computing device are articles of manufacture. Other examples of an article of manufacture include: an electronic component residing on a motherboard, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

An article of manufacture or system, in accordance with an embodiment of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Furthermore, examples and conditional language recited herein are principally intended to aid the reader in understanding the principles of the invention and the concepts contributed by the inventors to furthering the art and are to be construed as being without limitation to such specifically recited examples and conditions. Moreover, statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The scope of the invention, therefore, is not intended to be limited to the exemplary embodiments or the various aspects shown and described herein. Rather, the scope and spirit of the present invention is embodied by the appended claims.

What is claimed is:

1. A method of delivering voice content, the method comprising:
serving the voice content that includes a promoted phrase in one language;
detecting the user speaking the promoted phrase, wherein a portion of the promoted phrase is spoken by the user in another language resulting in a two-language spoken promoted phrase;
adding the two-language spoken promoted phrase, including the portion of the promoted phrase spoken in another language, to a database of recognized promoted phrases; and
serving additional content after the spoken promoted phrase is detected.

2. The method of claim 1 wherein detecting the spoken promoted phrase is performed within a time frame.

3. The method of claim 2 further comprising disabling detection of the spoken promoted phrase after the time frame has lapsed.

4. The method of claim 1 wherein the additional content is an advertisement and related to the promoted phrase.

5. The method of claim 1, wherein the additional content includes at least one question.

6. The method of claim 5 further comprising:
detecting a response to the at least one question; and
serving follow-up content based on the response.

7. The method of claim 6 wherein the follow-up content is an advertisement.

8. The method of claim 1 further comprising detecting a user interacting with a device using a wake-up phrase for the device.

9. The method of claim 1 wherein the step of detecting includes:
determining that the voice content was served; and
capturing the spoken promoted phrase when the user is the same user that was served the voice content.

10. A method comprising:
delivering, using a first device, voice content that includes a promoted phrase in first language;
detecting, using a second device, a user speaking the promoted phrase after the promoted phrase is provided, wherein a portion of the promoted phrase is spoken by the user in a second language;
adding the spoken promoted phrase, including the portion of the promoted phrase spoken in the second language, to a database of recognized promoted phrases and
serving, using at least one of the first device and the second device, additional content after the spoken promoted phrase is detected.

11. The method of claim 10 wherein the additional content is served using the first device.

12. The method of claim 10 wherein the additional content is served using the second device.

13. A method of identifying an engagement opportunity comprising:
delivering voice content that includes a promoted phrase;
monitoring for a spoken natural language response that includes the promoted phrase;
detecting the spoken natural language response, wherein a portion of the spoken natural language response is in a different language resulting in a spoken two-language response;
analyzing the spoken natural two-language response to determine if the promoted phrase was spoken as part of the spoken natural two-language response;
adding the spoken two-language response, which includes the portion spoken in a different language, to a database of recognized phrases if the spoken promoted phrase is detected in the spoken two-language response; and
identifying content to provide in response to the spoken promoted phrase.
